(19) United States
(12) Patent Application Publication
(10) Pub. No.: US 2013/0053010 A1
(43) Pub. Date: Feb. 28, 2013

(54) APPARATUS AND METHOD FOR PERFORMING A CALL CONNECTION IN PORTABLE TERMINAL

(71) Applicant: Dong-Ha KIM, Gyeongsangbuk-do (KR)

(72) Inventor: Dong-Ha KIM, Gyeongsangbuk-do (KR)

(73) Assignee: SAMSUNG ELECTRONICS CO., LTD., Gyeonggi-do (KR)

(21) Appl. No.: 13/597,531

(22) Filed: Aug. 29, 2012

(30) Foreign Application Priority Data
Aug. 30, 2011 (KR) 10-2011-0087428

(51) Int. Cl. H04W 76/00; H04W 4/16

(52) U.S. Cl. 455/415; 455/418

(57) ABSTRACT

The present disclosure relates to an apparatus and a method for performing a call connection in a portable terminal, by which it is possible to reduce the consumption of a battery of the portable terminal when a call connection is performed by the portable terminal including one RF unit and at least two SIM cards. The apparatus includes: at least two Subscriber Identity Module (SIM) cards; and a controller for performing a control operation so as to perform a call connection over a relevant communication network of a SIM card among the at least two SIM cards, which has the larger electric field value of the relevant communication network.

### CLAIM OF PRIORITY

This application claims priority under 35 U.S.C. §119 to a Korean Patent Application entitled “Apparatus and Method for Performing Phone Call in Portable Terminal” filed in the Korean Intellectual Property Office on Aug. 30, 2011 and assigned Serial No. 10-2011-0087428, the contents of which are incorporated herein by reference.

### BACKGROUND OF THE INVENTION

1. Field of the Invention

The present invention relates to an apparatus and a method for performing a call connection in a portable terminal, while reducing the consumption of a battery of the portable terminal.

2. Description of the Related Art

Generally, a portable terminal having one SIM card installed therein is mainly used, but recently, a portable terminal having two SIM cards has been introduced. As such, a user can use two phone numbers in a single portable terminal using the two SIM cards.

When one of the SIM cards is selected and activated as described above, the user of the portable terminal performs a call connection over a communication network using the activated SIM card regardless of the electric field states, such as a RSSI (Received Signal Strength Indication) which in turn can increase the battery consumption during operation.

### SUMMARY OF THE INVENTION

Accordingly, an aspect of the present invention is to solve the above-mentioned problems, by providing an apparatus and a method for performing a call connection in a portable terminal while reducing the consumption of a battery of the portable terminal having one RF unit and at least two SIM cards.

In accordance with an aspect of the present invention, an apparatus for performing a call connection in a portable terminal includes: at least two Subscriber Identity Module (SIM) cards; and a controller for performing a control operation so as to perform a call connection over a relevant communication network of a SIM card having a larger electric field value (i.e, higher RSSI) among the two SIM cards.

In accordance with another aspect of the present invention, a method for performing a call connection in a portable terminal includes: determining which SIM card among at least two SIM cards has a larger electric field value of a relevant communication network; and automatically switching to the relevant communication network of the SIM card having the larger electric field value to perform the call connection.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a portable terminal according to an exemplary embodiment of the present invention; and

FIG. 2 is a flowchart illustrating a method for performing a call connection by a portable terminal according to an exemplary embodiment of the present invention.

### DETAILED DESCRIPTION

Hereinafter, exemplary embodiments of the present invention will be described in detail with reference to the accompanying drawings. It should be noted that, in the accompanying drawings, the same elements will be designated by the same reference numerals throughout the following description and drawings although they may be shown in different drawings.

Although a portable terminal is described in the specification as having, for illustrative purpose, two SIM (Subscriber Identity Module) cards in an exemplary embodiment of the present invention, it should be noted that the portable terminal may perform an identical operation regardless of the number of SIM cards installed therein. Thus, the number of SIM cards should not limit the scope of the invention.

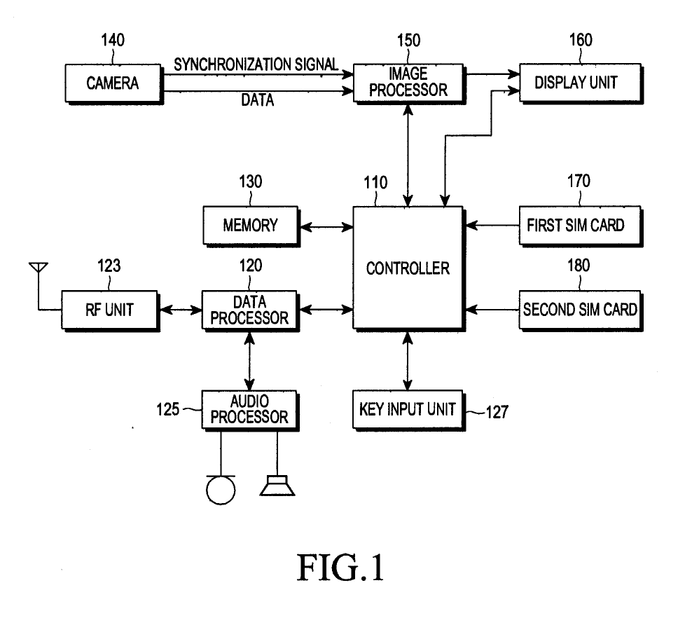

FIG. 1 is a block diagram illustrating the configuration of a portable terminal according to an exemplary embodiment of the present invention.

In operation, an RF unit 123 performs a wireless communication function of the portable terminal. The RF unit 123 includes an RF transmitter for upconverting the frequency of a signal to be transmitted and then amplifying the frequency-upconverted signal, an RF receiver for low-noise amplifying a received signal and then downconverting the frequency of the low-noise amplified signal, etc.

A data processor 120 includes a transmitter for encoding and modulating a signal to be transmitted, and a receiver for demodulating and decoding a signal received by the RF unit 123, etc. Namely, the data processor 120 may include a modem (modulator/demodulator) and a codec (coder/decoder). In this case, the codec includes a data codec for processing packet data and the like, and an audio codec for processing audio signals including voice and the like.

An audio processor 125 reproduces a received audio signal, which has been output from the audio codec of the data processor 120, or transmits an audio signal to be transmitted, which is generated from a microphone, to the audio codec of the data processor 120.

A key input unit 127 may include keys for inputting numbers and text information, and function keys for setting various functions.

A memory 130 may include a program memory and a data memory. The program memory may store programs for controlling a general operation of the portable terminal, and programs for performing a control operation so as to perform a call connection over a communication network using one of the two SIM cards having a larger electric field value according to an exemplary embodiment of the present invention. Also, the data memory temporarily stores data generated while the programs are performed.

Further, according to an exemplary embodiment of the present invention, in a standby mode, when each of a first SIM card 170 and a second SIM card 180 transmits a signal to a relevant communication network in order to maintain a connection, the memory 130 stores an electric field value of the relevant communication network, such as a RSSI (Received Signal Strength Indication), acquired from a signal received as a response to the transmitted signal from the respective communication network.

The controller 110 controls an overall operation of the portable terminal.

According to an exemplary embodiment of the present invention, in a standby mode, when each of the first SIM card 170 and the second SIM card 180 transmits a signal to a relevant communication network on a predetermined cycle in order to maintain a connection to the relevant communication network, the controller 110 acquires an electric field value of the relevant communication network from a signal received as a response to the transmitted signal, and stores the acquired electric field value of the relevant communication network in the memory 130.

Also, according to an exemplary embodiment of the present invention, when a call connection is attempted, the controller 110 compares an electric field value (i.e., RSSI) of a communication network of one of the first SIM card 170 and the second SIM card 180, which has been activated by a user's selection or according to a predetermined time period, with an electric field value of a communication network of the other deactivated SIM card. When an electric field value of a communication network of the deactivated SIM card is larger than that of a communication network of the activated SIM card, the controller 110 switches to perform the call connection over the communication network of the deactivated SIM card. Otherwise, when an electric field value of a communication network of the deactivated SIM card is smaller than that of a communication network of the activated SIM card, the controller 110 make the call connection over the communication network of the activated SIM card. Note that the consumption of a battery is reduced when the call connection occurs at a higher electric field environment than a lower electric field environment.

Further, according to an exemplary embodiment of the present invention, when the call connection is completed using over the communication network of the deactivated SIM card which has a higher electric field value, the controller 110 performs, in a standby mode, a control operation of activating the deactivated SIM card. For example, when a first SIM card is activated and a second SIM card is deactivated, the call connection is performed using the network of the deactivated second SIM card having a lager electric field value, and after the completion of call connection, the second SIM card is activated and the first SIM card is deactivated.

Thus, according to an exemplary embodiment of the present invention, when automatic switching between communication networks has previously programmed to operate as stated above, the controller 110 performs a control operation for performing a call connection over a relevant communication network of one of the first SIM card 170 and the second SIM card 180 having a larger electric field value of the relevant communication network.

Each of the first SIM card 170 and the second SIM card 180, which is a module in the form of a card, may store personal information in order to provide various services including the authentication of a subscriber, charging information, security functions and the like, and stores a unique phone number.

A camera 140 includes a camera sensor for capturing image data and converting the captured light signal to an electrical signal, and a signal processor for converting the analog image signal, which has been captured by the camera sensor, to digital data. In this case, it is assumed that the camera sensor is a CCD (Charge-Coupled Device) sensor or a CMOS (Complementary Metal-Oxide Semiconductor) sensor, and the signal processor may be implemented by using a DSP (Digital Signal Processor). Also, the camera sensor and the signal processor may be implemented as one unit, or may be implemented as separate elements.

The image processor 150 performs ISP (Image Signal Processing) for displaying an image signal, which has been output from the camera 140, by a display unit 160. In this case, the term “ISP” refers to the execution of functions including a gamma correction, an interpolation, a spatial change, an image effect, an image scale, AWB (Auto White Balance), AE (Auto Exposure), AF (Auto Focus), etc. Therefore, the image processor 150 processes the image signal, which has been output from the camera 140, on a frame-by-frame basis, and outputs the frame image data in such a manner as to meet the characteristics and the size of the display unit 160. Also, the image processor 150 includes an image codec, and compresses the frame image data displayed by the display unit 160 in a set scheme, or restores the compressed frame image data to an original frame image data. In this case, the image codec may be implemented by using either a JPEG (Joint Photographic Coding Experts Group) codec, an MPEG-4 (Moving Picture Experts Group-4) codec, a Wavelet codec, or the like. It is assumed that the image processor 150 includes an OSD (On-Screen Display) function. The image processor 150 may output on-screen display data according to the size of a screen displayed under the control of the controller 110.

The display unit 160 displays an image signal, which has been output from the image processor 150, on a screen thereof, and displays user data which has been output from the controller 110. In this case, the display unit 160 may employ an LCD (Liquid Crystal Display), and thus may include an LCD controller, a memory capable of storing image data, an LCD display element, etc. When the LCD employs a touch screen, the display unit 160 may operate as an input unit. At this time, the display unit 160 may display keys which are identical to those of the key input unit 127.

Also, according to an exemplary embodiment of the present invention, the display unit 160 may display automatic switching of a communication network of an activated SIM card to a communication network of a deactivated SIM card having a larger electric field value so that the user is informed of the switch.

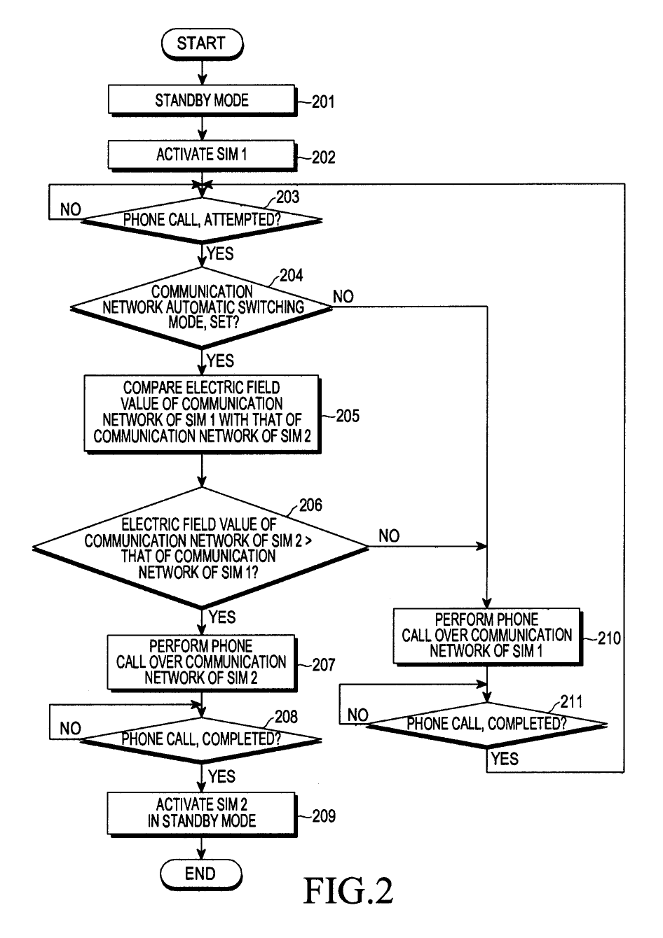

A method for performing a call connection by the portable terminal as described above will be described in detail below with reference to FIG. 2.

FIG. 2 is a flowchart illustrating a method for performing a call connection by a portable terminal according to an exemplary embodiment of the present invention.

Hereinafter, an exemplary embodiment of the present invention will be described in detail with reference to FIGS. 1 and 2.

Referring to FIG. 2, in step 201 where the portable terminal is in a standby mode, each of the first SIM card 170 and the second SIM card 180 maintains a connection to a relevant communication network in a time sharing scheme. The controller 110 performs a control operation in the standby mode so that each of the first SIM card 170 and the second SIM card 180 transmits a signal to a relevant communication network on a predetermined cycle in order to maintain a connection to the relevant communication network. In the standby mode, when a response signal to the transmitted signal is received, the controller 110 extracts an electric field value (i.e., RSSI) of the relevant communication network from the response signal, and then stores the extracted electric field value in the memory 130.

In step 202 where the first SIM card (i.e. SIM 1) 170, which is one of the first SIM card 170 and the second SIM card 180, is activated by a user's selection or activated according to a predetermined time period, when a call connection is attempted, the controller 110 first senses the attempt of the call connection in step 203, and then determines in step 204 whether an automatic switching between communication networks has been set.

When automatic switching between communication networks has been set, the controller 110 senses a result of the determination in step 204, and the controller 110 proceeds to step 205. In step 205, the controller 110 compares an electric field value of a communication network of the activated first SIM card 170 and an electric field value of a communication network of the deactivated second SIM card (i.e. SIM 2) 180, which are stored in the memory 130 until just before the attempt of the call connection.

When a result of the comparison in step 205 shows that an electric field value of a communication network of the deactivated second SIM card 180 is larger than that of a communication network of the activated first SIM card 170, the controller 110 performs a control operation of automatically switching to the communication network of the second SIM card 180 in step 206 to make the call connection over the switched communication network of the second SIM card 180 in step 207.

In step 207, the controller 110 may control the display unit 160 so as to display the automatic switching to inform the user.

When the call connection has been performed over the communication network of the second SIM card 180 and is completed in step 207, the controller 110 senses the completion of the call connection in step 208, and proceeds to step 209. In step 209, the controller 110 performs a control operation of switching to a standby mode and activating the second SIM card 180.

Also, when the call connection is performed over the communication network of the deactivated a second SIM card 180, the controller 110 may perform a control operation of changing Caller Identification Display (CID) and transmitting the changed CID so that a caller's phone number corresponding to the second SIM card 180 is displayed by a portable terminal of a counterpart.

In step 209, the controller 110 performs a control operation of deactivating the first SIM card 170 and activating the second SIM card 180 having a larger electric field value than that of a communication network of the first SIM card 170. In the standby mode, in step 209, the controller 110 may control the display unit 160 so as to display that the second SIM card 180 has been activated.

Otherwise, if a call connection is attempted in a state of activating the first SIM card 170 when the mode for automatically switching between communication networks has not been set, the controller 110 senses in step 204 that the automatic switching mode has not been set, and proceeds to step 210. In step 210, the controller 110 performs a control operation for performing a call connection over the communication network of the first SIM card 170 which is now activated.

Otherwise, when a result of the comparison in step 205 shows that an electric field value of a communication network of the activated first SIM card 170 is larger than the deactivated second SIM card 180, the controller 110 proceeds to step 210 where a call connection is performed over the communication network of the first SIM card 170 which has been activated in step 206 and is now activated.

When the call connection has been performed over the communication network of the first SIM card 170 and is completed in step 210, the controller 110 senses the completion of the call connection in step 211, and proceeds to step 202. In step 202, the controller 110 performs a control operation of switching to a standby mode and maintaining the activation of the first SIM card 170.

As described above, according to the apparatus and the method proposed in the present invention, a call connection is performed over a relevant communication network of a SIM card having a larger electric field value in the portable terminal including one RF unit and at least two SIM cards. Therefore, it is possible to reduce the consumption of a battery of the portable terminal.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the specific exemplary embodiments such as a portable terminal have been shown and described in the description of the present invention as described above, various changes in form and details may be made in the specific exemplary embodiments of the present invention without departing from the spirit and scope of the present invention. Therefore, the spirit and scope of the present invention is not limited to the described embodiments thereof, but is defined by the appended claims and equivalents.

What is claimed is:

1. An apparatus for performing a call connection in a portable terminal, comprising:
at least two Subscriber Identity Module (SIM) cards; and
a controller for performing a call connection over one of the at least two SIM cards corresponding to a communication network having a larger electric field regardless of an activated state of either two SIM cards.

2. The apparatus as claimed in claim 1, wherein the controller compares an electric field value of a communication network of an activated SIM card and an electric field value of a communication network of a deactivated SIM card when the call connection is attempted, and switches to the communication network of the deactivated SIM card to perform the call connection when the electric field value of the communication network of the deactivated SIM card is larger than the electric field value of the communication network of the activated SIM card.

3. The apparatus as claimed in claim 2, wherein the controller performs, in a standby mode, a control operation for activating the deactivated SIM card after the call connection is completed via the deactivated SIM card.

4. The apparatus as claimed in claim 2, wherein the controller performs a control operation for performing the call connection over the communication network of the activated SIM card when the electric field value of the communication network of the deactivated SIM card is smaller than the electric field value of the communication network of the activated SIM card.

5. The apparatus as claimed in claim 1, wherein, in a standby mode, the controller acquires an electric field value of the relevant communication network in response to a request signal transmitted by each of the at least two SIM cards to the relevant communication network.

6. The apparatus as claimed in claim 1, wherein the controller stores, in a standby mode, an electric field value of the relevant communication network received in response to a request signal transmitted by each of the at least two SIM cards for a subsequent retrieval.

7. The apparatus as claimed in claim 1, wherein the controller performs a control operation for performing the call connection over the relevant communication network of the SIM card having a larger electric field value of the relevant communication network, when automatic switching between communication networks has previously been set.

8. The apparatus as claimed in claim 1, further comprising a display for displaying a notice informing of the call connection over a relevant communication network via one of the at least two SIM cards having a larger electric field value of the relevant communication network.

9. The apparatus as claimed in claim 1, wherein the controller compares an electric field value of a communication network of the activated first SIM card and the deactivated second SIM card that are stored in a memory prior to performing the call connection.

10. The apparatus as claimed in claim 1, wherein the controller transmits information relating to a Caller Identification Display (CID) of one of the at least two SIM cards having a larger electric field value to a receiving terminal.

11. A method for performing a call connection in a portable terminal, the method comprising:
determining which SIM card among at least two SIM cards having a larger electric field value of a relevant communication network; and
automatically switching to the relevant communication network of the SIM card having a larger electric field value to perform the call connection regardless of an activated state of either two SIM cards.

12. The method as claimed in claim 11, wherein the determining step comprises comparing an electric field value of a communication network of an activated SIM card and an electric field value of a communication network of a deactivated SIM card when the call connection is attempted.

13. The method as claimed in claim 11, wherein determining of which SIM card among the at least two SIM cards comprises:
determining whether an automatic switching between communication networks has previously been set when the call connection is attempted; and
determining which SIM card among the at least two SIM cards has a larger electric field value of the relevant communication network when the automatic switching between the communication networks has previously been set.

14. The method as claimed in claim 11, wherein performing of the call connection comprises automatically switching to a communication network of a deactivated SIM card and performing the call connection over the communication network of the deactivated SIM card when an electric field value of the deactivated SIM card is larger than an electric field value of an activated SIM card.

15. The method as claimed in claim 14, further comprising activating the deactivated SIM card in a standby mode, when the call connection is completed via the deactivated SIM card.

16. The method as claimed in claim 14, further comprising performing the call connection over the communication network of the activated SIM card when the electric field value of the deactivated SIM card is smaller than the electric field value of the activated SIM card.

17. The method as claimed in claim 11, further comprising in a standby mode, acquiring an electric field value of the relevant communication network in response to a signal by each of the at least two SIM cards transmitted to the relevant communication network.

18. The method as claimed in claim 12, further comprising displaying a notice informing of the switching to the relevant communication network of the SIM card.

19. The method as claimed in claim 11, further comprising storing an electric field value of the communication network of the activated first SIM card and the deactivated second SIM prior to performing the call connection.

20. The method as claimed in claim 11, further comprising transmitting information relating to a Caller Identification Display (CID) of one of the at least two SIM cards having a larger electric field value to a receiving terminal.
